(19) United States
(12) Patent Application Publication
(10) Pub. No.: US 2008/0088564 A1
(43) Pub. Date: Apr. 17, 2008

(54) Driving Circuit of Liquid Crystal Display

(75) Inventors: Lee-Hsun Chang, Hsin-Chu (TW); Jing-Ru Chen, Hsin-Chu (TW); Yu-Wen Lin, Hsin-Chu (TW); Yung-Tse Cheng, Hsin-Chu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORPORATION, Hsin-Chu (TW)

(21) Appl. No.: 11/758,228

(22) Filed: Jun. 5, 2007

(30) Foreign Application Priority Data
Oct. 17, 2006 (TW) 95138250

(51) Int. Cl. G09G 3/36

(52) U.S. Cl. 345/99

(57) ABSTRACT

A driving circuit includes a plurality of connected driving circuit units, and each of the driving circuit units includes an input unit, an output unit, a first control unit, a second control unit, and a pull-down circuit. Each of the driving circuit units receives a start signal and a clock signal to output an output signal to a next driving circuit unit. The first control unit, the second control unit, and the pull-down circuit are used to release the accumulative charges of the circuit and stabilize the output signal.

### RELATED APPLICATIONS

This application claims priority to Taiwan Patent Application Serial Number 95138250, filed Oct. 17, 2006, which is herein incorporated by reference.

### BACKGROUND

1. Field of Invention

The present invention relates to a driving circuit. More particularly, the present invention relates to a driving circuit for use in a liquid crystal display.

2. Description of Related Art

In recent years, technology has continued to develop significantly and different types of electronic products available change day by day. Among the various electronic products, liquid crystal displays have many advantages such as thin volume, low power consumption, and compatible with current semiconductor fabrication processes. So liquid crystal displays have gradually become the mainstream among various candidates of flat panel displays. In the liquid crystal display, the driving circuit is usually one of the important parts. Therefore, how to improve the driving circuit is becoming an urgent issue.

For a recently developed driving circuit of a liquid crystal display, the driving circuit including a plurality of driving circuit units is manufactured on the glass substrate, and the driving circuit units sequentially output the driving signals to the scan lines, so that the conventional driving integrated circuit can be replaced and thus the high cost of using the conventional driving integrated circuit can be reduced. However, when using this skill, charges would be accumulated in the driving circuit during the operation and thus result in the driving circuit not being able to output stable driving signals.

In the prior art, the output signal of a driving circuit unit is transmitted back to a previous driving circuit unit to release the accumulative charges in the previous driving circuit unit and stabilize the output signal from the previous driving circuit unit. However, due to the increasing sizes of liquid crystal displays, the charging transistor is also becoming bigger and the circuit load is increasing, so that more charges are accumulated and result in driving circuit delays and errors.

For the foregoing reasons, there is a need to provide a driving circuit to avoid too many accumulative charges and the error of the driving circuit.

### SUMMARY

It is therefore an object of the present invention to provide a driving circuit to solve the issue of too many accumulative charges and output the driving signal steadily to avoid the error of the driving circuit.

In accordance with one embodiment of the present invention, the driving circuit is controlled with a clock signal to drive a plurality of scan lines of a liquid crystal display. The driving circuit includes a plurality of cascade-connected driving circuit units, wherein each of the driving circuit units comprises an input unit, an output unit, a first control unit, a second control unit and a pull-down circuit. The input unit receives a start signal to generate a first signal. The output unit electrically couples to the input unit and receives the clock signal and the first signal to output an output signal, and transmits the output signal to a next driving circuit unit to be the start signal for the next driving circuit unit. The first control unit electrically couples to the input unit, the output unit and a power voltage and receives the output signal of the next driving circuit unit. The second control unit electrically couples to the input unit, the output unit and the power voltage and receives the output signal of a driving circuit unit two driving circuit units after. The pull-down circuit electrically couples to the input unit, the output unit and the power voltage.

By using the foregoing driving circuit, the error caused by the accumulative charges can be avoided and the driving signal can be outputted steadily.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the preferred embodiment, with reference made to the accompanying drawings where:

FIG. 1 shows the driving circuit unit according to the first embodiment of the present invention;

FIG. 2 is a diagram showing the driving circuit unit according to the second embodiment of the present invention;

FIG. 3 is a diagram showing the driving circuit unit according to the third embodiment of the present invention;

FIG. 4 is a clock diagram of the operation of the driving circuit unit according to one embodiment of the present invention;

FIG. 5 is a diagram showing the driving circuit unit according to the fourth embodiment of the present invention;

FIG. 6 is a diagram showing the driving circuit unit according to the fifth embodiment of the present invention;

FIG. 7 is a diagram showing the driving circuit unit according to the sixth embodiment of the present invention;

FIG. 8 is another clock diagram of the operation of the driving circuit unit according to another embodiment of the present invention; and

FIG. 9 is a diagram showing the liquid crystal display panel according to one embodiment of the present invention.

### DESCRIPTION OF THE PREFERRED EMBODIMENTS

Detailed illustrative embodiments of the present invention are disclosed herein. However, specific details disclosed herein are merely representative for purposes of describing exemplary embodiments of the present invention. This invention may, however, be embodied in many alternate forms and should not be construed as limited to the embodiments set forth herein.

The first embodiment of the present invention provides a driving circuit to solve the problem of too many accumulative charges and output the driving signals steadily to prevent driving circuit errors.

The driving circuit is controlled with a clock signal to drive a plurality of scan lines of a liquid crystal display, and further includes a plurality of identical cascade-connected driving circuit units. The clock signal is divided into a positive phase clock signal CK and an opposite phase clock signal XCK, and phases of these two clock signals are opposite. One of every two adjacent driving circuit units receives the positive phase clock signal CK and the other one receives the opposite phase clock signal XCK. According to one embodiment, if the N-th driving circuit unit receives the positive phase clock signal CK, the (N+1)-th and the (N−1)-th driving circuit unit receive the opposite 10 phase clock signal XCK.

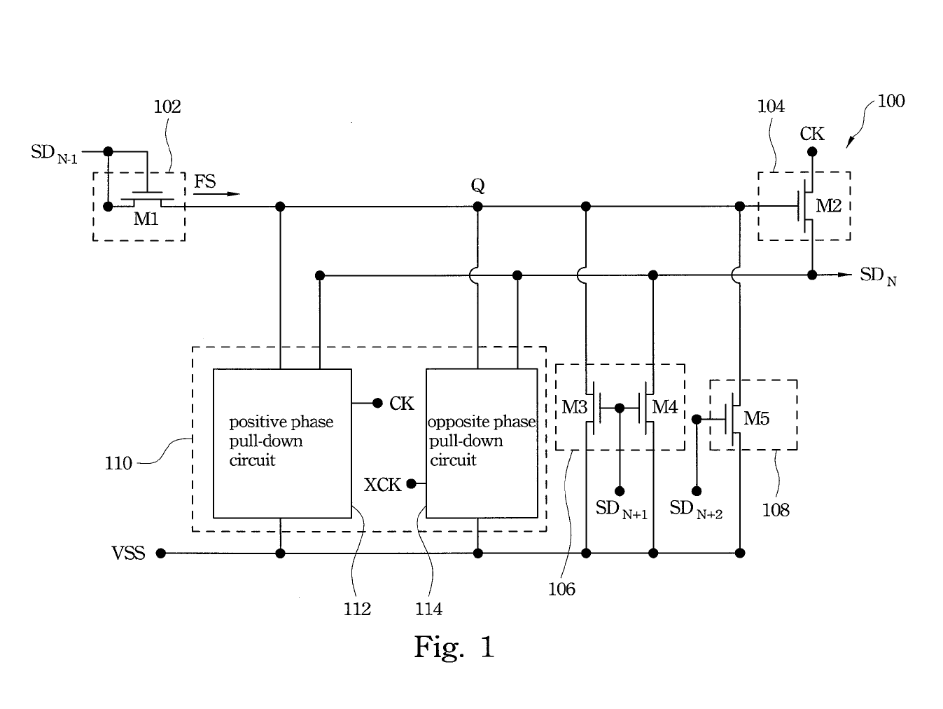

FIG. 1 shows the driving circuit unit according to the first embodiment of the present invention. Referring to FIG. 1 and taking the N-th driving circuit unit 100 for example, the driving circuit unit 100 includes an input unit 102, an output unit 104, a first control unit 106, a second control unit 108 and a pull-down circuit 110. In the N-th driving circuit unit 100, the output unit 104 receives the positive phase clock signal CK and outputs a present, i.e. the N-th, driving signal SD_{N} to the scan line. The input unit 102 receives the driving signal SD_{N-1}, outputted from the previous, i.e. the (N−1)-th, driving circuit unit, to be the present, i.e. the N-th, start signal, and the input unit 102 is electrically coupled to the output unit 104 and generates a first signal FS to be transmitted to the output unit 104. The first control unit 106 is also electrically coupled to the input unit 102, the output unit 104 and a power voltage VSS, and receives the driving signal SD_{N+1} outputted from the next, i.e. the (N+1)-th, driving circuit unit. The second control unit 108 is electrically coupled to the input unit 102, the output unit 104, and the power voltage VSS as well, and receives the driving signal SD_{N+2} outputted from the driving circuit unit two driving circuit units after, i.e. the (N+2)-th driving circuit unit. In addition, the pull-down circuit 110 is electrically coupled to the input unit 102, the output unit 104, and the power voltage VSS as well, so as to stabilize the present driving signal SD_{N} outputted from the output unit 104.

In the present embodiment, taking the N-th driving circuit unit 100 for example, the input unit 102 includes a transistor Ml. Both the gate electrode and the first source/drain electrode of the transistor M1 receive the driving signal SD_{N-1} outputted from the previous, i.e. the (N−1)-th, driving circuit unit. The second source/drain electrode of the transistor M1 generates the first signal FS to be transmitted to the output unit 104. The output unit 104 includes a transistor M2. The gate electrode of the transistor M2 is electrically coupled to the second source/drain electrode of the transistor M1 and receives the first signal FS, and the first source/drain electrode of the transistor M2 receives the positive phase clock signal CK, and the second source/drain electrode of the transistor M2 outputs the present, i.e. the N-th, driving signal SD_{N} to the scan line and also transmits the driving signal SD_{N} to the next, i.e. the (N+1)-th, driving circuit unit to be the driving signal.

Furthermore, the first control unit 106 includes a transistor M3 and a transistor M4. The gate electrodes of the transistors M3 and M4 are electrically coupled to each other and receive the driving signal SD_{N+1} outputted from the next, i.e. the (N+1)-th, driving circuit unit. The second source/drain electrodes of the transistors M3 and M4 are electrically coupled to the power voltage VSS. The first source/drain electrode of the transistor M3 is electrically coupled to the gate electrode of the transistor M2, and the first source/drain electrode of the transistor M4 is electrically coupled to the second source/drain electrode of the transistor M2.

The second control unit 108 includes a transistor M5. The gate electrode of the transistor M5 receives the driving signal SD_{N+2} outputted from the driving circuit unit two driving circuit units after, i.e. the (N+2)-th driving circuit unit, and the first source/drain electrode of the transistor M5 is electrically coupled to the gate electrode of the transistor M2, and the second source/drain electrode of the transistor M5 is electrically coupled to the power voltage VSS. Furthermore, the pull-down circuit 110 includes a positive phase pull-down circuit 112 and an opposite phase pull-down circuit 114. Both the positive phase pull-down circuit 112 and the opposite phase pull-down circuit 114 are electrically coupled to the gate electrode and the second source/drain electrode of the transistor M2 and the power voltage VSS. The positive phase pull-down circuit 112 stabilizes the present driving signal SD_{N} in response to the positive phase clock signal CK, and the opposite phase pull-down circuit 114 stabilizes the present driving signal SD_{N} in response to the opposite phase clock signal XCK.

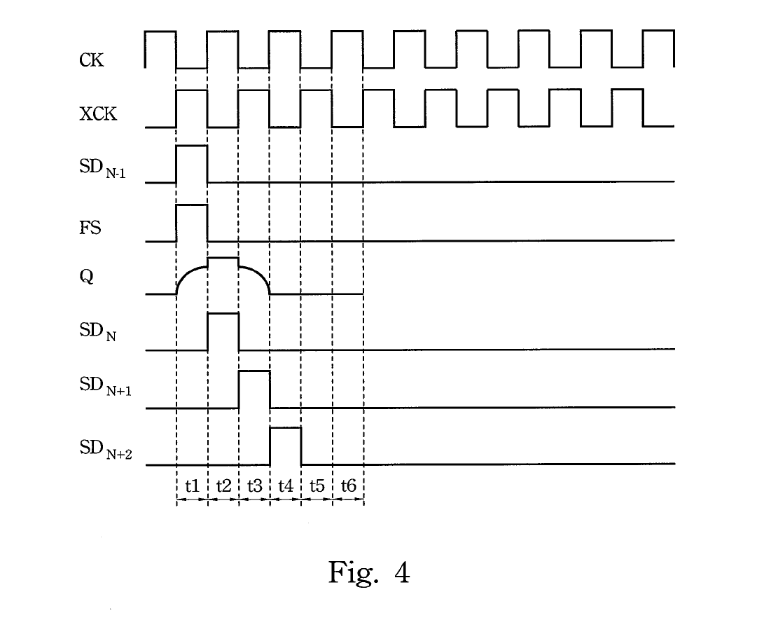

The operation of the driving circuit unit 100 of the present embodiment is described as follows. FIG. 4 is a timing diagram of the operation of the driving circuit unit according to one embodiment of the present invention. Referring to FIG. 1 and FIG. 4 and taking the N-th driving circuit unit 100 for example, during the time period t1, the driving signal SD_{N-1} outputted from the previous, i.e. the (N−1)-th, driving circuit unit is at a high voltage level and transmitted to the gate electrode and the first source/drain electrode of the transistor M1, so as to turn on the transistor M1. The driving signal SD_{N-1} received by the first source/drain electrode is transmitted to the second source/drain electrode through the transistor M1 to be the first signal FS and transmitted to the transistor M2. At this time, the node Q in FIG. 1 is connected with many elements, so the potential of the node Q, shown in FIG. 4, increases slowly in response to the first signal FS.

Then during the time period t2, the positive phase clock signal CK changes from a low voltage level to a high voltage level and is transmitted to the first source/drain electrode of the transistor M2, and the potential of the node Q increases to a high voltage level, so that the transistor M2 is turned on and transmits the positive phase clock signal CK to be the present, i.e. the N-th, driving signal SD_{N} to drive the corresponding scan line of the liquid crystal display. The driving signal SD_{N} is also transmitted to the next stage to be the driving signal of the next, i.e. the (N+1)-th, driving circuit unit.

During the time period t3, the driving signal SD_{N+1}, generated by the (N+1)-th driving circuit unit which receives the driving signal SD_{N} outputted from the present, i.e. the N-th, driving circuit unit, is transmitted back to the electrically-connected common node of the transistors M3 and M4 of the N-th driving circuit unit 100, so that the transistors M3 and M4 are turned on to release the accumulative charges of the node Q and stabilize the driving signal SD_{N} to prevent circuit errors.

Similarly, during the time period t4, the driving signal SD_{N+2}, generated by the (N+2)-th driving circuit unit which receives the driving signal SD_{N+1} outputted from the (N+1)-th driving circuit unit, is transmitted back to the gate electrode of the transistor M5 of the N-th driving circuit unit 100, so that the transistors M5 is turned on to release the accumulative charges of the node Q to prevent circuit errors.

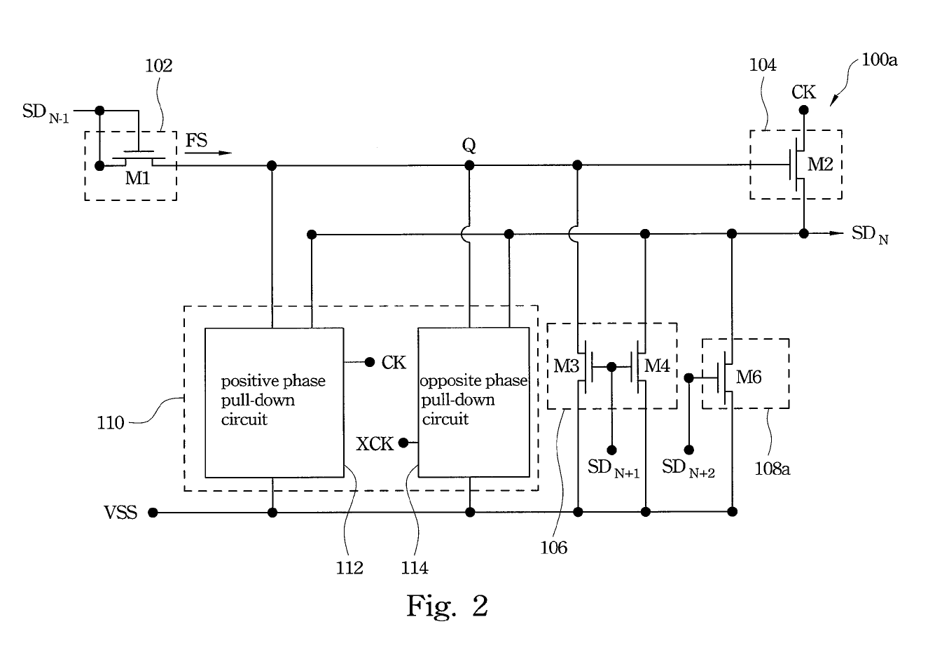

FIG. 2 is a diagram showing the driving circuit unit according to the second embodiment of the present invention. Referring to FIG. 2 and taking the N-th driving circuit unit 100a for example, the driving circuit unit 100a includes a second control unit 108a, and the input unit 102, the output unit 104, the first control unit 106 and the pull-down circuit 110 as shown in FIG. 1. Similarly, the input unit 102 receives the driving signal SD_{N-1} outputted from the previous, i.e. the (N−1)-th, driving circuit unit, and the output unit 104 receives the positive phase clock signal CK and outputs the present, i.e. the N-th, driving signal SD_{N} to the scan line. The first control unit 106 is also electrically coupled to the input unit 102, the output unit 104 and the power voltage VSS, and receives the driving signal SD_{N+1} outputted from the next, i.e. the (N+1)-th, driving circuit unit. Besides, the second control unit 108a is electrically coupled to the input unit 102, the output unit 104 and the power voltage VSS as well, and receives the driving signal SD_{N+2} outputted from the driving circuit unit two driving circuit units after, i.e. the (N+2)-th driving circuit unit. The pull-down circuit 110 is electrically coupled to the input unit 102, the output unit 104 and the power voltage VSS as well, so as to stabilize the present driving signal SD_{N} outputted from the output unit 104.

In the present embodiment, taking the N-th driving circuit unit 100a for example, the input unit 102 similarly includes the transistor M1 receiving the driving signal SD_{N-1} outputted from the previous, i.e. the (N−1)-th, driving circuit unit, and generating the first signal FS to be transmitted to the output unit 104. The output unit 104 similarly includes the transistor M2 receiving the first signal FS and the positive phase clock signal CK to output the present, i.e. the N-th, driving signal SD_{N} to the scan line and also transmitting the driving signal SD_{N} to the next, i.e. the (N+1)-th, driving circuit unit to be the driving signal.

Further, the first control unit 106 similarly includes the transistor M3 and the transistor M4. The gate electrodes of the transistors M3 and M4 are electrically coupled to each other and receive the driving signal SD_{N+1} outputted from the next, i.e. the (N+1)-th, driving circuit unit. The second source/drain electrodes of the transistors M3 and M4 are electrically coupled to the power voltage VSS. The first source/drain electrode of the transistor M3 is electrically coupled to the gate electrode of the transistor M2, and the first source/drain electrode of the transistor M4 is electrically coupled to the second source/drain electrode of the transistor M2.

The second control unit 108a includes a transistor M6. The gate electrode of the transistor M6 receives the driving signal SD_{N+2} outputted from the driving circuit unit two driving circuit units after, i.e. the (N+2)-th driving circuit unit, and the first source/drain electrode of the transistor M6 is electrically coupled to the second source/drain electrode of the transistor M2, and the second source/drain electrode of the transistor M6 is electrically coupled to the power voltage VSS. Further, the pull-down circuit 110 similarly includes the positive phase pull-down circuit 112 and the opposite phase pull-down circuit 114. Both the positive phase pull-down circuit 112 and the opposite phase pull-down circuit 114 are electrically coupled to the gate electrode and the second source/drain electrode of the transistor M2 and the power voltage VSS. The positive phase pull-down circuit 112 stabilizes the present driving signal SD_{N} according to the positive phase clock signal CK, and the opposite phase pull-down circuit 114 stabilizes the present driving signal SD_{N} according to the opposite phase clock signal XCK.

The operation of the driving circuit unit 100a of the present embodiment is described as follows, and the operation is similar to that of the first embodiment. Referring to FIG. 2 and FIG. 4 and taking the N-th driving circuit unit 100a for example, during the time period t1, the driving signal SD_{N-1} outputted from the previous, i.e. the (N−1)-th, driving circuit unit is at a high voltage level and transmitted to the gate electrode and the first source/drain electrode of the transistor M1, so as to turn on the transistor M1. The driving signal SD_{N-1} received by the first source/drain electrode is transmitted to the second source/drain electrode through the transistor M1 to be the first signal FS and transmitted to the transistor M2. At this time, the node Q in FIG. 2 is connected with many elements, so the potential of the node Q, shown in FIG. 4, increases slowly according to the first signal FS.

Then during the time period t2, the positive phase clock signal CK changes from a low voltage level to a high voltage level and is transmitted to the first source/drain electrode of the transistor M2, and the potential of the node Q increases to a high level, so that the transistor M2 is turned on and transmits the positive phase clock signal CK to be the present, i.e. the N-th, driving signal SD_{N} to drive the scan line of the liquid crystal display. The driving signal SD_{N} is also transmitted to the next stage to be the driving signal of the next, i.e. the (N+1)-th, driving circuit unit.

During the time period t3, the driving signal SD_{N+1}, generated by the (N+1)-th driving circuit unit which receives the driving signal SD_{N} outputted from the present, i.e. the N-th, driving circuit unit, is transmitted back to the common node of the transistors M3 and M4 of the N-th driving circuit unit 100a, so that the transistors M3 and M4 are turned on to release the accumulative charges of the node Q and stabilize the driving signal SD_{N} to prevent circuit errors.

Similarly, during the time period t4, the driving signal SD_{N+2}, generated by the (N+2)-th driving circuit unit which receives the driving signal SD_{N+1} outputted from the (N+1)-th driving circuit unit, is transmitted back to the gate electrode of the transistor M6 of the N-th driving circuit unit 100a, so that the transistors M6 is turned on to release the accumulative charges of the node Q to prevent circuit errors.

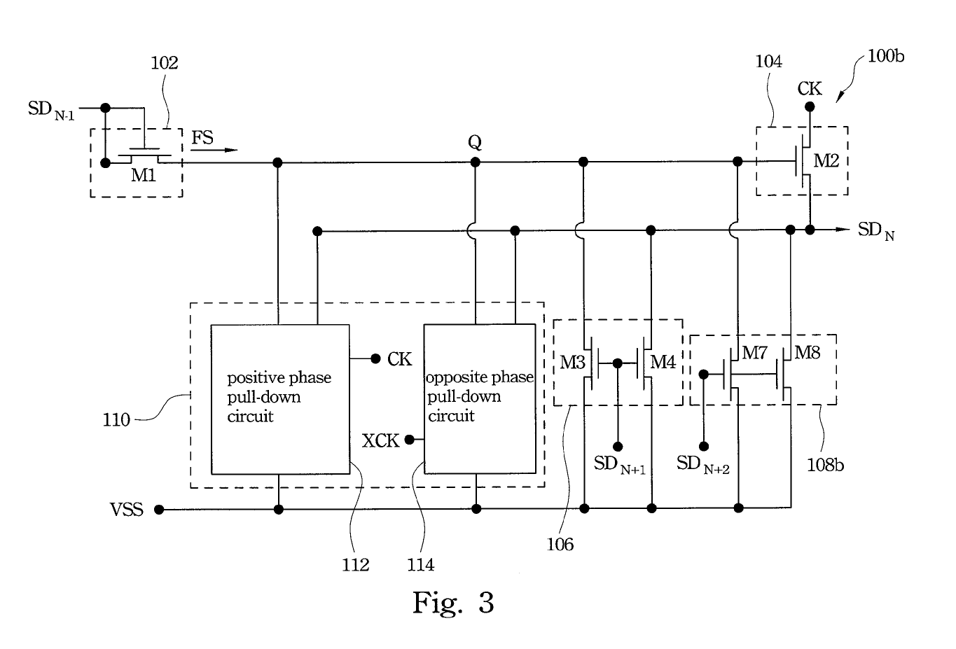

FIG. 3 is a diagram showing the driving circuit unit according to the third embodiment of the present invention. Referring to FIG. 3 and taking the N-th driving circuit unit 100b for example, the driving circuit unit 100b includes a second control unit 108b, and the input unit 102, the output unit 104, the first control unit 106 and the pull-down circuit 110 as shown in FIG. 1. Similarly, the input unit 102 receives the driving signal SD_{N-1} outputted from the previous, i.e. the (N−1)-th, driving circuit unit, and the output unit 104 receives the positive phase clock signal CK and outputs the present, i.e. the N-th, driving signal SD_{N} to the scan line. The first control unit 106 is also electrically coupled to the input unit 102, the output unit 104 and the power voltage VSS, and receives the driving signal SD_{N+1} outputted from the next, i.e. the (N+1)-th, driving circuit unit. Besides, the second control unit 108b is electrically coupled to the input unit 102, the output unit 104 and the power voltage VSS as well, and receives the driving signal SD_{N+2} outputted from the driving circuit unit two driving circuit units after, i.e. the (N+2)-th driving circuit unit. The pull-down circuit 110 is electrically coupled to the input unit 102, the output unit 104 and the power voltage VSS as well, so as to stabilize the present driving signal SD_{N} outputted from the output unit 104.

In the present embodiment, taking the N-th driving circuit unit 100b for example, the input unit 102 similarly includes the transistor M1 receiving the driving signal SD_{N-1} outputted from the previous, i.e. the (N−1)-th, driving circuit unit, and generating the first signal FS to be transmitted to the output unit 104. The output unit 104 similarly includes the transistor M2 receiving the first signal FS and the positive phase clock signal CK to output the present, i.e. the N-th, driving signal SD_{N} to the scan line and also transmitting the driving signal SD_{N} to the next, i.e. the (N+1)-th, driving circuit unit to be the driving signal.

Further, the first control unit 106 similarly includes the transistor M3 and the transistor M4. The gate electrodes of the transistors M3 and M4 are electrically coupled to each other and receive the driving signal SD_{N+1} outputted from the next, i.e. the (N+1)-th, driving circuit unit. The second source/drain electrodes of the transistors M3 and M4 are electrically coupled to the power voltage VSS. The first source/drain electrode of the transistor M3 is electrically coupled to the gate electrode of the transistor M2, and the first source/drain electrode of the transistor M4 is electrically coupled to the second source/drain electrode of the transistor M2.

The second control unit 108b includes a transistor M7 and a transistor M8. Both the gate electrodes of the transistors M7 and M8 receive the driving signal SD_{N+2} outputted from the driving circuit unit two driving circuit units after, i.e. the (N+2)-th driving circuit unit, and the second source/drain electrodes of the transistors M7 and M8 are electrically coupled to the power voltage VSS. The first source/drain electrode of the transistor M7 is electrically coupled to the gate electrode of the transistor M2, and the first source/drain electrode of the transistor M8 is electrically coupled to the second source/drain electrode of the transistor M2. Further, the pull-down circuit 110 similarly includes the positive phase pull-down circuit 112 and the opposite phase pull-down circuit 114. Both the positive phase pull-down circuit 112 and the opposite phase pull-down circuit 114 are electrically coupled to the gate electrode and the second source/drain electrode of the transistor M2 and the power voltage VSS. The positive phase pull-down circuit 112 stabilizes the present driving signal SD_{N} according to the positive phase clock signal CK, and the opposite phase pull-down circuit 114 stabilizes the present driving signal SD_{N} according to the opposite phase clock signal XCK.

The operation of the driving circuit unit 100b of the present embodiment is described as follows, and the operation is similar to that of the first embodiment. Referring to FIG. 3 and FIG. 4 and taking the N-th driving circuit unit 100b for example, during the time period t1, the driving signal SD_{N-1} outputted from the previous, i.e. the (N−1)-th, driving circuit unit is at a high voltage level and transmitted to the gate electrode and the first source/drain electrode of the transistor M1, so as to turn on the transistor M1. The driving signal SD_{N-1} received by the first source/drain electrode is transmitted to the second source/drain electrode through the transistor M1 to be the first signal FS and transmitted to the transistor M2. At this time, the node Q in FIG. 3 is connected with many elements, so the potential of the node Q, shown in FIG. 4, increases slowly according to the first signal FS.

Then during the time period t2, the positive phase clock signal CK changes from a low voltage level to a high voltage level and is transmitted to the first source/drain electrode of the transistor M2, and the potential of the node Q increases to a high level, so that the transistor M2 is turned on and transmits the positive phase clock signal CK to be the present, i.e. the N-th, driving signal SD_{N} to drive the scan line of the liquid crystal display. The driving signal SD_{N} is also transmitted to the next stage to be the driving signal of the next, i.e. the (N+1)-th, driving circuit unit.

During the time period t3, the driving signal SD_{N+1}, generated by the (N+1)-th driving circuit unit which receives the driving signal SD_{N} outputted from the present, i.e. the N-th, driving circuit unit, is transmitted back to the common node of the transistors M3 and M4 of the N-th driving circuit unit 100b, so that the transistors M3 and M4 are turned on to release the accumulative charges of the node Q and stabilize the driving signal SD_{N} to prevent circuit errors.

Similarly, during the time period t4, the driving signal SD_{N+2}, generated by the (N+2)-th driving circuit unit which receives the driving signal SD_{N+1} outputted from the (N+1)-th driving circuit unit, is transmitted back to the gate electrodes of the transistors M7 and M8 of the N-th driving circuit unit 100b, so that the transistors M7 and M8 are turned on to release the accumulative charges of the node Q to prevent circuit errors.

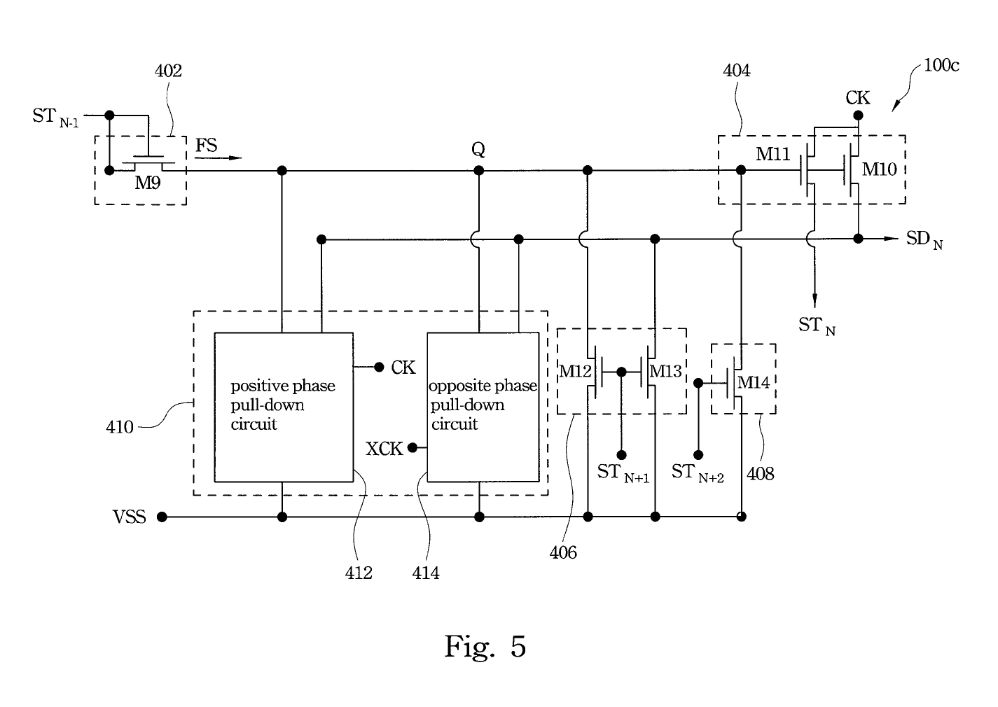

FIG. 5 is a diagram showing the driving circuit unit according to the fourth embodiment of the present invention. Referring to FIG. 5 and taking the N-th driving circuit unit 100c for example, the driving circuit unit 100c includes an input unit 402, an output unit 404, a first control unit 406, a second control unit 408 and a pull-down circuit 410. In the N-th driving circuit unit 100c, the output unit 404 receives the positive phase clock signal CK, and outputs a present, i.e. the N-th, driving signal SD_{N} to the scan line and a carry signal ST_{N} to the next, i.e. the (N+1)-th, driving circuit unit to be the driving signal for the next stage. The input unit 402 receives the carry signal ST_{N-1}, outputted from the previous, i.e. the (N−1)-th, driving circuit unit, to be the present, i.e. the N-th, start signal, and the input unit 402 is electrically coupled to the output unit 404 and generates a first signal FS to be transmitted to the output unit 404. Besides, the first control unit 406 is electrically coupled to the input unit 402, the output unit 404 and a power voltage VSS, and receives the carry signal ST_{N+1} outputted from the next, i.e. the (N+1)-th, driving circuit unit. The second control unit 408 is electrically coupled to the input unit 402, the output unit 404 and the power voltage VSS as well, and receives the carry signal ST_{N+2} outputted from the driving circuit unit two driving circuit units after, i.e. the (N+2)-th driving circuit unit. In addition, the pull-down circuit 410 is electrically coupled to the input unit 402, the output unit 404 and the power voltage VSS as well, so as to stabilize the present driving signal SD_{N} outputted from the output unit 404.

In the present embodiment, taking the N-th driving circuit unit 100c for example, the input unit 402 includes a transistor M9. Both the gate electrode and the first source/drain electrode of the transistor M9 receive the carry signal ST_{N-1} outputted from the previous, i.e. the (N−1)-th, driving circuit unit, and the second source/drain electrode of the transistor M9 generates the first signal FS to be transmitted to the output unit 404. The output unit 404 includes a transistor M10 and a transistor M11. Both the gate electrodes of the transistors M10 and M11 are electrically coupled to the second source/drain electrode of the transistor M9 and receive the first signal FS. Both the first source/drain electrodes of the transistors M10 and M11 receive the positive phase clock signal CK. The second source/drain electrode of the transistor M10 outputs the present, i.e. the N-th, driving signal SD_{N} to the scan line, and the second source/drain electrode of the transistor M11 outputs the present, i.e. the N-th, carry signal ST_{N} to the next, i.e. the (N+1)-th, driving circuit unit to be the driving signal.

Further, the first control unit 406 includes a transistor M12 and a transistor M13. The gate electrodes of the transistors M12 and M13 are electrically coupled to each other and receive the carry signal ST_{N+1} outputted from the next, i.e. the (N+1)-th, driving circuit unit. The second source/drain electrodes of the transistors M12 and M13 are electrically coupled to the power voltage VSS. The first source/drain electrode of the transistor M12 is electrically coupled to the gate electrode of the transistor M11, and the first source/drain electrode of the transistor M13 is electrically coupled to the second source/drain electrode of the transistor M10.

The second control unit 408 includes a transistor M14. The gate electrode of the transistor M14 receives the carry signal ST_{N+2} outputted from the driving circuit unit two driving circuit units after, i.e. the (N+2)-th driving circuit unit, and the first source/drain electrode of the transistor M14 is electrically coupled to the gate electrode of the transistor M11, and the second source/drain electrode of the transistor M14 is electrically coupled to the power voltage VSS. Further, the pull-down circuit 410 includes a positive phase pull-down circuit 412 and an opposite phase pull-down circuit 414. Both the positive phase pull-down circuit 412 and the opposite phase pull-down circuit 414 are electrically coupled to the gate electrode of the transistor M11 and the second source/drain electrode of the transistor M10 and the power voltage VSS. The positive phase pull-down circuit 412 stabilizes the present driving signal SD_{N} according to the positive phase clock signal CK, and the opposite phase pull-down circuit 414 stabilizes the present driving signal SD_{N} according to the opposite phase clock signal XCK.

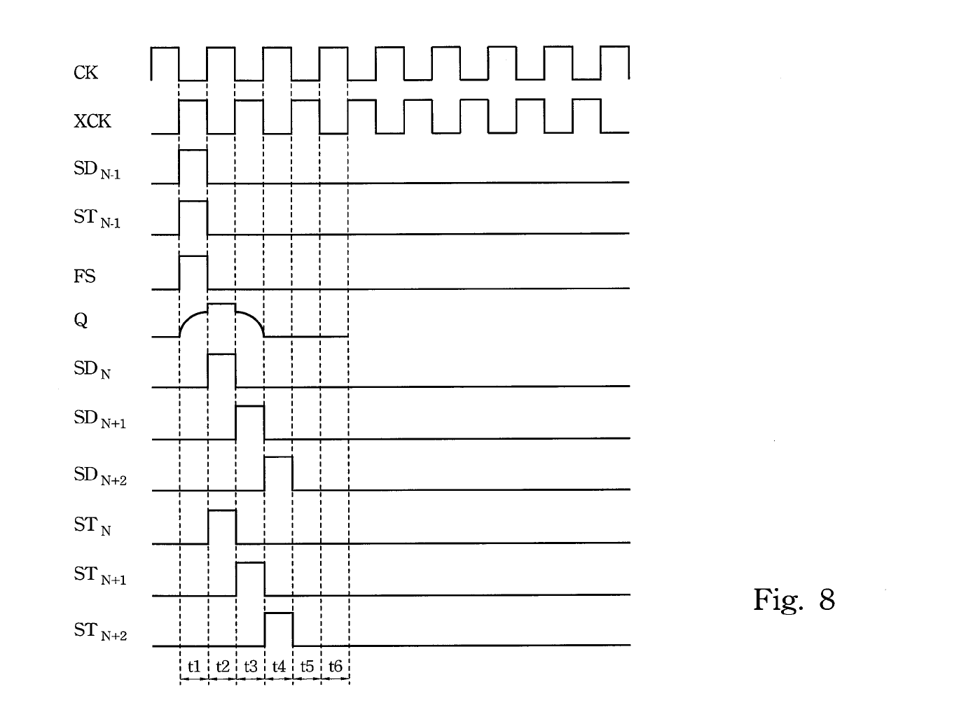

The operation of the driving circuit unit 100c of the present embodiment is described as follows. FIG. 8 is another clock diagram of the operation of the driving circuit unit according to another embodiment of the present invention. Referring to FIG. 5 and FIG. 8 and taking the N-th driving circuit unit 100c for example, during the time period t1, the carry signal ST_{N-1} outputted from the previous, i.e. the (N−1)-th, driving circuit unit is at a high voltage level and transmitted to the gate electrode and the first source/drain electrode of the transistor M9, so as to turn on the transistor M9. The carry signal ST_{N-1} received by the first source/drain electrode is transmitted to the second source/drain electrode through the transistor M9 to be the first signal FS and transmitted to the transistors M10 and M11. At this time, the node Q in FIG. 5 is connected with many elements, so the potential of the node Q, shown in FIG. 8, increases slowly according to the first signal FS.

Then during the time period t2, the positive phase clock signal CK changes from a low voltage level to a high voltage level and is transmitted to the first source/drain electrodes of the transistors M10 and M11, and the potential of the node Q increases to a high level, so that the transistors M10 and M11 are turned on, and the transistor M10 transmits the positive phase clock signal CK to be the present, i.e. the N-th, driving signal SD_{N} to drive the scan line of the liquid crystal display, and the transistor M11 transmits the positive phase clock signal CK to be the present, i.e. the N-th, carry signal ST_{N} and transmits the carry signal ST_{N} to the next, i.e. the (N+1)-th, driving circuit unit to be the driving signal.

During the time period t3, the carry signal ST_{N+1}, generated by the (N+1)-th driving circuit unit which receives the carry signal ST_{N} outputted from the present, i.e. the N-th, driving circuit unit, is transmitted back to the common node of the transistors M12 and M13 of the N-th driving circuit unit 100c, so that the transistors M12 and M13 are turned on to release the accumulative charges of the node Q and stabilize the driving signal SD_{N} to prevent circuit errors.

Similarly, during the time period t4, the carry signal ST_{N+2}, generated by the (N+2)-th driving circuit unit which receives the carry signal ST_{N+1} outputted from the (N+1)-th driving circuit unit, is transmitted back to the gate electrode of the transistor M14 of the N-th driving circuit unit 100c, so that the transistors M14 is turned on to release the accumulative charges of the node Q to prevent circuit errors.

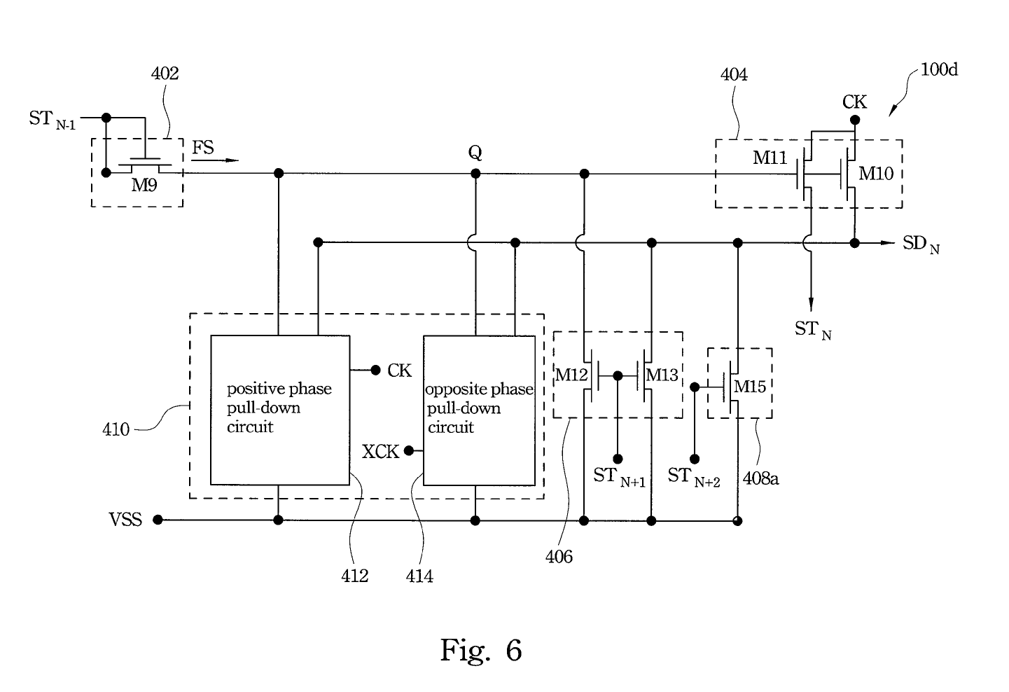

FIG. 6 is a diagram showing the driving circuit unit according to the fifth embodiment of the present invention. Referring to FIG. 6 and taking the N-th driving circuit unit 100d for example, the driving circuit unit 100d includes a second control unit 408a, and the input unit 402, the output unit 404, the first control unit 406 and the pull-down circuit 410 as shown in FIG. 4. Similarly, the input unit 402 receives the carry signal ST_{N-1} outputted from the previous, i.e. the (N−1)-th, driving circuit unit, and the output unit 404 receives the positive phase clock signal CK and outputs the present, i.e. the N-th, driving signal SD_{N} to the scan line and outputs the carry signal ST_{N} to the next, i.e. the (N+1)-th, driving circuit unit to be the driving signal for the next stage. The first control unit 406 is also electrically coupled to the input unit 402, the output unit 404 and the power voltage VSS, and receives the carry signal ST_{N+1} outputted from the next, i.e. the (N+1)-th, driving circuit unit. Besides, the second control unit 408a is electrically coupled to the input unit 402, the output unit 404 and the power voltage VSS as well, and receives the carry signal ST_{N+2} outputted from the driving circuit unit two driving circuit units after, i.e. the (N+2)-th driving circuit unit. The pull-down circuit 410 is electrically coupled to the input unit 402, the output unit 404 and the power voltage VSS as well, so as to stabilize the present driving signal SD_{N} outputted from the output unit 404.

In the present embodiment, taking the N-th driving circuit unit 100d for example, the input unit 402 similarly includes the transistor M9 receiving the carry signal ST_{N-1} outputted from the previous, i.e. the (N−1)-th, driving circuit unit, and generating the first signal FS to be transmitted to the output unit 404. The output unit 404 similarly includes the transistors M10 and M11 receiving the first signal FS and the positive phase clock signal CK to output the present, i.e. the N-th, driving signal SD_{N} to the scan line and output the present, i.e. the N-th, carry signal ST_{N} to the next, i.e. the (N+1)-th, driving circuit unit to be the driving signal.

Further, the first control unit 406 similarly includes the transistor M12 and the transistor M13. The gate electrodes of the transistors M12 and M13 are electrically coupled to each other and receive the carry signal ST_{N+1} outputted from the next, i.e. the (N+1)-th, driving circuit unit. The second source/drain electrodes of the transistors M12 and M13 are electrically coupled to the power voltage VSS. The first source/drain electrode of the transistor M12 is electrically coupled to the gate electrode of the transistor M11, and the first source/drain electrode of the transistor M13 is electrically coupled to the second source/drain electrode of the transistor M10.

The second control unit 408a includes a transistor M15. The gate electrode of the transistor M15 receives the carry signal ST_{N+2} outputted from the driving circuit unit two driving circuit units after, i.e. the (N+2)-th driving circuit unit, and the first source/drain electrode of the transistor M15 is electrically coupled to the second source/drain electrode of the transistor M10, and the second source/drain electrode of the transistor M15 is electrically coupled to the power voltage VSS. Further, the pull-down circuit 410 similarly includes the positive phase pull-down circuit 412 and the opposite phase pull-down circuit 414. Both the positive phase pull-down circuit 412 and the opposite phase pull-down circuit 414 are electrically coupled to the gate electrode of the transistor M11, the second source/drain electrode of the transistor M10 and the power voltage VSS. The positive phase pull-down circuit 412 stabilizes the present driving signal SD_{N} according to the positive phase clock signal CK, and the opposite phase pull-down circuit 414 stabilizes the present driving signal SD_{N} according to the opposite phase clock signal XCK.

The operation of the driving circuit unit 100d of the present embodiment is described as follows, and the operation is similar to that of the fourth embodiment. Referring to FIG. 6 and FIG. 8 and taking the N-th driving circuit unit 100d for example, during the time period t1, the carry signal ST_{N-1} outputted from the previous, i.e. the (N−1)-th, driving circuit unit is at a high voltage level and transmitted to the gate electrode and the first source/drain electrode of the transistor M9, so as to turn on the transistor M9. The carry signal ST_{N-1} received by the first source/drain electrode is transmitted to the second source/drain electrode through the transistor M9 to be the first signal FS and transmitted to the transistors M10 and M11. At this time, the node Q in FIG. 6 is connected with many elements, so the potential of the node Q, shown in FIG. 8, increases slowly according to the first signal FS.

Then during the time period t2, the positive phase clock signal CK changes from a low voltage level to a high voltage level and is transmitted to the first source/drain electrodes of the transistors M10 and M11, and the potential of the node Q increases to a high level, so that the transistors M10 and M11 are turned on. The transistor M10 transmits the positive phase clock signal CK to be the present, i.e. the N-th, driving signal SD_{N} to drive the scan line of the liquid crystal display, and the transistor M11 transmits the positive phase clock signal CK to be the present, i.e. the N-th, carry signal ST_{N} and transmits the carry signal ST_{N} to the next, i.e. the (N+1)-th, driving circuit unit to be the driving signal.

During the time period t3, the carry signal ST_{N+1}, generated by the (N+1)-th driving circuit unit which receives the carry signal ST_{N} outputted from the present, i.e. the N-th, driving circuit unit, is transmitted back to the common node of the transistors M12 and M13 of the N-th driving circuit unit 100d, so that the transistors M12 and M13 are turned on to release the accumulative charges of the node Q and stabilize the driving signal SD_{N} to prevent circuit errors.

Similarly, during the time period t4, the carry signal ST_{N+2}, generated by the (N+2)-th driving circuit unit which receives the carry signal ST_{N+1} outputted from the (N+1)-th driving circuit unit, is transmitted back to the gate electrode of the transistor M15 of the N-th driving circuit unit 100d, so that the transistor M15 is turned on to release the accumulative charges of the node Q to prevent circuit errors.

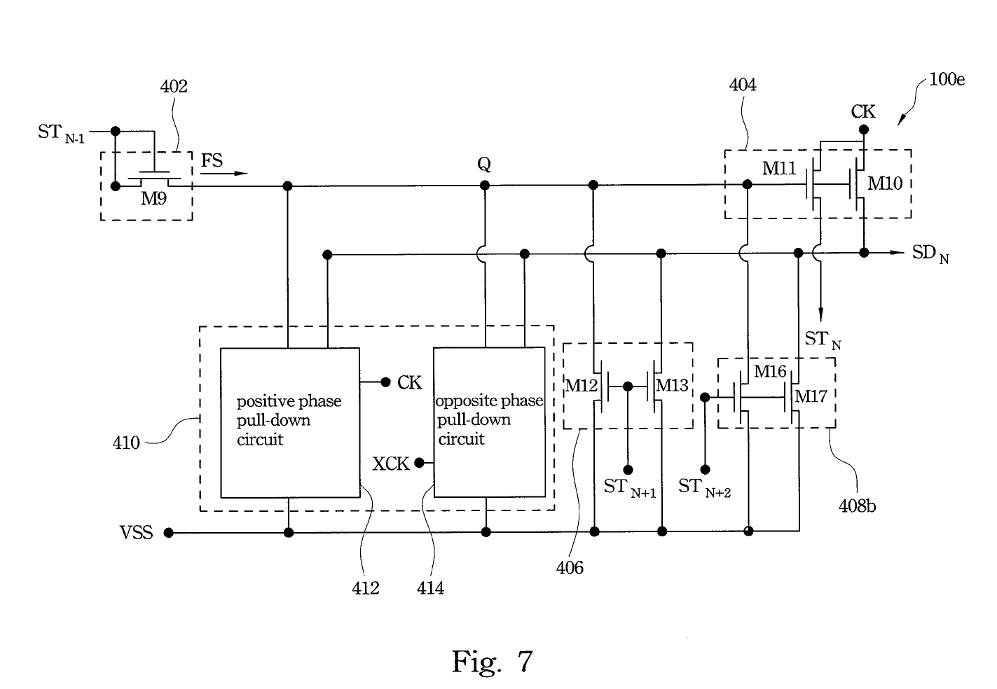

FIG. 7 is a diagram showing the driving circuit unit according to the sixth embodiment of the present invention. Referring to FIG. 7 and taking the N-th driving circuit unit 100e for example, the driving circuit unit 100e includes a second control unit 408b, and the input unit 402, the output unit 404, the first control unit 406 and the pull-down circuit 410 as shown in FIG. 4. Similarly, the input unit 402 receives the carry signal ST_{N-1} outputted from the previous, i.e. the (N−1)-th, driving circuit unit, and the output unit 404 receives the positive phase clock signal CK and outputs the present, i.e. the N-th, driving signal SD_{N} to the scan line and outputs the carry signal ST_{N} to the next, i.e. the (N+1)-th, driving circuit unit to be the driving signal for the next stage. The first control unit 406 is similarly electrically coupled to the input unit 402, the output unit 404 and the power voltage VSS, and receives the carry signal ST_{N+1} outputted from the next, i.e. the (N+1)-th, driving circuit unit. Besides, the second control unit 408b is electrically coupled to the input unit 402, the output unit 404 and the power voltage VSS as well, and receives the carry signal ST_{N+2} outputted from the driving circuit unit two driving circuit units after, i.e. the (N+2)-th driving circuit unit. The pull-down circuit 410 is electrically coupled to the input unit 402, the output unit 404 and the power voltage VSS as well, so as to stabilize the present driving signal SD_{N} outputted from the output unit 404.

In the present embodiment, taking the N-th driving circuit unit 100e for example, the input unit 402 similarly includes the transistor M9 receiving the carry signal ST_{N-1} outputted from the previous, i.e. the (N−1)-th, driving circuit unit, and generating the first signal FS to be transmitted to the output unit 404. The output unit 404 similarly includes the transistors M10 and M11 coupling to the transistor M9, and receiving the first signal FS and the positive phase clock signal CK to output the present, i.e. the N-th, driving signal SD_{N} to the scan line and output the present, i.e. the N-th, carry signal ST_{N} to the next, i.e. the (N+1)-th, driving circuit unit to be the driving signal.

Further, the first control unit 406 similarly includes the transistor M12 and the transistor M13. The gate electrodes of the transistors M12 and M13 are electrically coupled to each other and receive the carry signal ST_{N+1} outputted from the next, i.e. the (N+1)-th, driving circuit unit. The second source/drain electrodes of the transistors M12 and M13 are electrically coupled to the power voltage VSS. The first source/drain electrode of the transistor M12 is electrically coupled to the gate electrode of the transistor M11, and the first source/drain electrode of the transistor M13 is electrically coupled to the second source/drain electrode of the transistor M10.

The second control unit 408b includes a transistor M16 and a transistor M17. The gate electrodes of the transistors M16 and M17 receive the carry signal ST_{N+2} outputted from the driving circuit unit two driving circuit units after, i.e. the (N+2)-th driving circuit unit, and the second source/drain electrodes of the transistors M16 and M17 are electrically coupled to the power voltage VSS. The first source/drain electrode of the transistor M16 is electrically coupled to the gate electrode of the transistor M11, and the first source/drain electrode of the transistor M17 is electrically coupled to the second source/drain electrode of the transistor M10. Further, the pull-down circuit 410 similarly includes the positive phase pull-down circuit 412 and the opposite phase pull-down circuit 414. Both the positive phase pull-down circuit 412 and the opposite phase pull-down circuit 414 are electrically coupled to the gate electrode of the transistor M11, the second source/drain electrode of the transistor M10 and the power voltage VSS. The positive phase pull-down circuit 412 stabilizes the present driving signal SD_{N} according to the positive phase clock signal CK, and the opposite phase pull-down circuit 414 stabilizes the present driving signal SD_{N} according to the opposite phase clock signal XCK.

The operation of the driving circuit unit 100e of the present embodiment is described as follows, and the operation is similar to that of the fourth embodiment. Referring to FIG. 7 and FIG. 8 and taking the N-th driving circuit unit 100e for example, during the time period t1, the carry signal ST_{N-1} outputted from the previous, i.e. the (N−1)-th, driving circuit unit is at a high voltage level and transmitted to the gate electrode and the first source/drain electrode of the transistor M9, so as to turn on the transistor M9. The carry signal ST_{N-1} received by the first source/drain electrode is transmitted to the second source/drain electrode through the transistor M9 to be the first signal FS and transmitted to the transistors M10 and M11. At this time, the node Q in FIG. 7 is connected with many elements, so the potential of the node Q, shown in FIG. 8, increases slowly according to the first signal FS.

Then during the time period t2, the positive phase clock signal CK changes from a low voltage level to a high voltage level and is transmitted to the first source/drain electrodes of the transistors M10 and M11, and the potential of the node Q increases to a high level, so that the transistors M10 and M11 are turned on. The transistor M10 transmits the positive phase clock signal CK to be the present, i.e. the N-th, driving signal SD_{N} to drive the scan line of the liquid crystal display, and the transistor M11 transmits the positive phase clock signal CK to be the present, i.e. the N-th, carry signal ST_{N} and transmits the carry signal ST_{N} to the next, i.e. the (N+1)-th, driving circuit unit to be the driving signal.

During the time period t3, the carry signal ST_{N+1}, generated by the (N+1)-th driving circuit unit which receives the carry signal ST_{N} outputted from the present, i.e. the N-th, driving circuit unit, is transmitted back to the common node of the transistors M12 and M13 of the N-th driving circuit unit 100e, so that the transistors M12 and M13 are turned on to release the accumulative charges of the node Q and stabilize the driving signal SD_{N} to prevent circuit errors.

Similarly, during the time period t4, the carry signal ST_{N+2}, generated by the (N+2)-th driving circuit unit which receives the carry signal ST_{N+1} outputted from the (N+1)-th driving circuit unit, is transmitted back to the gate electrode of the transistors M16 and M17 of the N-th driving circuit unit 100e, so that the transistors M16 and M17 are turned on to release the accumulative charges of the node Q to prevent circuit errors.

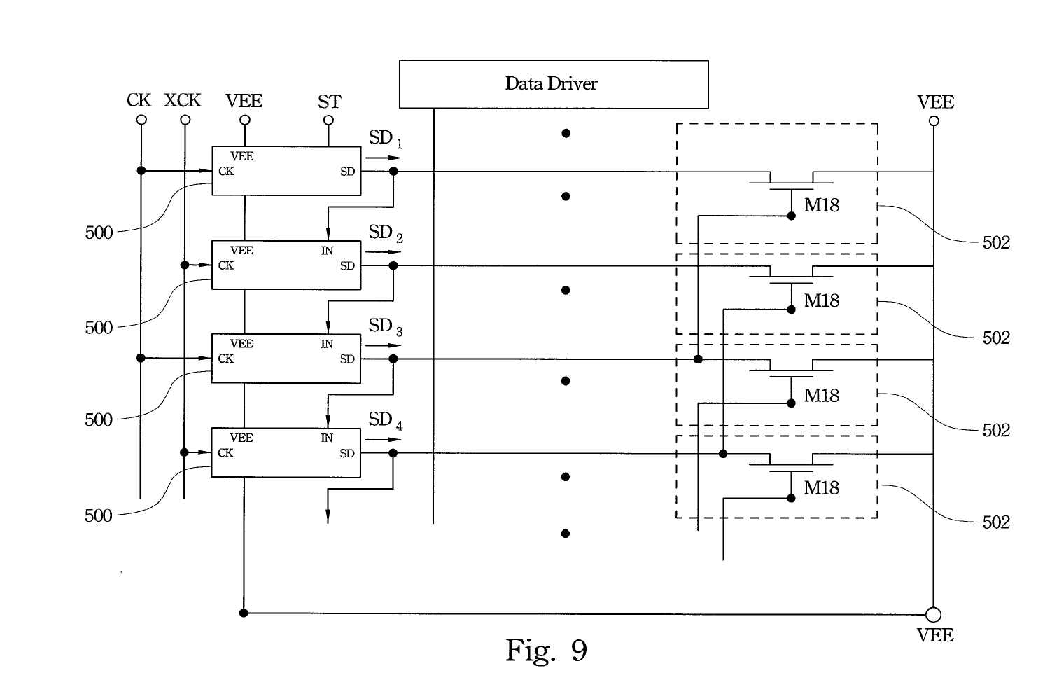

Except for the foregoing embodiments, the driving circuit can further include a plurality of control units, placed at one side opposite to the driving circuit of a liquid crystal display panel, to be used to stabilize the driving signals. FIG. 9 is a diagram showing the liquid crystal display panel according to one embodiment of the present invention. In accordance with the present embodiment, the driving circuit includes a plurality of driving circuit units 500 placed at one side of the display panel, and a plurality of third control units 502 placed at the other side of the display panel. The third control units 502 are electrically coupled to the driving circuit units 500, respectively, and one of the third control units 502 receives the driving signal outputted from the driving circuit unit 500 two driving circuit units 500 after, so as to stabilize the driving signals SD₁ . . . SD_{N} outputted from the driving circuit units 500. Taking the N-th stage of the third control units 502 for example, the N-th stage of the third control units 502 receives the driving signal SD_{N+2} outputted from the (N+2)-th driving circuit unit 500 to stabilize the driving signal SD_{N} outputted from the N-th driving circuit unit 500. Each of the third control units 502 includes a transistor M18. The gate electrode of the transistor M18 receives the output signal outputted from the driving circuit unit 500 two driving circuit units 500 after, and the first source/drain electrode of the transistor M18 is electrically coupled to the driving circuit unit 500, and the second source/drain electrode of the transistor M18 is electrically coupled to a power voltage VSS. So, each transistor M18 can be sequentially turned on by receiving the driving signal outputted from the driving circuit unit 500 two driving circuit units 500 after to stabilize the driving signals SD₁ . . . SD_{N} outputted from the driving circuit units 500.

As is understood with the foregoing embodiments of the present invention, the accumulative charges of a driving circuit unit can be released by transmitting back the driving signals, outputted from the next driving circuit unit and the driving circuit unit two driving circuit units after, to the driving circuit unit, so as to extend the usage life of the driving circuit. In addition, as is understood with the other foregoing embodiments of the present invention, if the losses of the driving signals, caused from transmitting the driving signals back to the driving circuit units, are to be avoided, each of the driving circuit units can output a carry signal, and the carry signals, outputted from the next driving circuit unit and the driving circuit unit two driving circuit units after, are transmitted back to a driving circuit unit, so as to release the accumulative charges and extend the usage life of the driving circuit. Besides, the output driving signals can be stabilized to be correctly outputted and to prevent circuit errors.

As is understood by a person skilled in the art, the foregoing embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A driving circuit controlled with a clock signal to drive a plurality of scan lines of a liquid crystal display, the driving circuit comprising: a plurality of cascade-connected driving circuit units, each of the driving circuit units comprising:
an input unit for receiving a start signal to generate a first signal;
an output unit, electrically coupled to the input unit, for receiving the clock signal and the first signal to output an output signal, wherein the output unit transmits the output signal to a next driving circuit unit to be the start signal for the next driving circuit unit;
a first control unit, electrically coupled to the input unit, the output unit and a power voltage, for receiving the output signal of the next driving circuit unit;
a second control unit, electrically coupled to the input unit, the output unit is and the power voltage, for receiving the output signal of a driving circuit unit two driving circuit units after; and
a pull-down circuit electrically coupled to the input unit, the output unit and the power voltage.

2. The driving circuit of claim 1, wherein the output unit further comprises:
a first transistor having a gate electrode electrically coupled to the input unit to receive the first signal, a first source/drain electrode for receiving the clock signal, and a second source/drain electrode for outputting the output signal to be the start signal for the next driving circuit unit and to be a driving signal for driving the scan line.

3. The driving circuit of claim 2, wherein the second control unit further comprises:
a second transistor having a gate electrode for receiving the driving signal of the driving circuit unit two driving circuit units after, a first source/drain electrode electrically coupled to the gate electrode of the first transistor, and a second source/drain electrode electrically coupled to the power voltage.

4. The driving circuit of claim 2, wherein the second control unit further comprises:
a third transistor having a gate electrode for receiving the driving signal of the driving circuit unit two driving circuit units after, a first source/drain electrode electrically coupled to the second source/drain electrode of the first transistor, and a second source/drain electrode electrically coupled to the power voltage.

5. The driving circuit of claim 2, wherein the second control unit further comprises:
a fourth transistor having a gate electrode for receiving the driving signal of the driving circuit unit two driving circuit units after, a first source/drain electrode electrically coupled to the gate electrode of the first transistor, and a second source/drain electrode electrically coupled to the power voltage; and
a fifth transistor having a gate electrode for receiving the driving signal of the driving circuit unit two driving circuit units after, a first source/drain electrode electrically coupled to the second source/drain electrode of the first transistor, and a second source/drain electrode electrically coupled to the power voltage.

6. The driving circuit of claim 2, wherein the first control unit further comprises:
a sixth transistor having a gate electrode for receiving the driving signal of the next driving circuit unit, a first source/drain electrode electrically coupled to the gate electrode of the first transistor, and a second source/drain electrode electrically coupled to the power voltage; and
a seventh transistor having a gate electrode for receiving the driving signal of the next driving circuit unit, a first source/drain electrode electrically coupled to the second source/drain electrode of the first transistor, and a second source/drain electrode electrically coupled to the power voltage.

7. The driving circuit of claim 2, wherein the input unit further comprises:
an eighth transistor, a gate and a first source/drain electrode of the eighth transistor receiving the driving signal of a previous driving circuit unit, a second source/drain electrode of the eighth transistor coupling to the gate electrode of the first transistor.

8. The driving circuit of claim 1, wherein the output unit further comprises:
a ninth transistor having a gate electrode electrically coupled to the input unit to receive the first signal, a first source/drain electrode for receiving the clock signal, and a second source/drain electrode for outputting a driving signal to drive the scan line; and
a tenth transistor having a gate electrode electrically coupled to the input unit to receive the first signal, a first source/drain electrode for receiving the clock signal, and a second source/drain electrode for outputting the output signal to be a carry signal used as the start signal for the next driving circuit unit.

9. The driving circuit of claim 8, wherein the second control unit further comprises:
an eleventh transistor having a gate electrode for receiving the carry signal of the driving circuit unit two driving circuit units after, a first source/drain electrode electrically coupled to the gate electrode of the tenth transistor, and a second source/drain electrode electrically coupled to the power voltage.

10. The driving circuit of claim 8, wherein the second control unit further comprises:
a twelfth transistor having a gate electrode for receiving the carry signal of the driving circuit unit two driving circuit units after, a first source/drain electrode electrically coupled to the second source/drain electrode of the ninth transistor, and a second source/drain electrode electrically coupled to the power voltage.

11. The driving circuit of claim 8, wherein the second control unit further comprises:
a thirteenth transistor having a gate electrode for receiving the carry signal of the driving circuit unit two driving circuit units after, a first source/drain electrode electrically coupled to the gate electrode of the tenth transistor, and a second source/drain electrode electrically coupled to the power voltage; and
a fourteenth transistor having a gate electrode for receiving the carry signal of the driving circuit unit two driving circuit units after, a first source/drain electrode electrically coupled to the second source/drain electrode of the ninth transistor, and a second source/drain electrode electrically coupled to the power voltage.

12. The driving circuit of claim 8, wherein the first control unit further comprises:
a fifteenth transistor having a gate electrode for receiving the carry signal of the next driving circuit unit, a first source/drain electrode electrically coupled to the gate electrode of the tenth transistor, and a second source/drain electrode electrically coupled to the power voltage; and
a sixteenth transistor having a gate electrode for receiving the carry signal of the next driving circuit unit, a first source/drain electrode electrically coupled to the second source/drain electrode of the ninth transistor, and a second source/drain electrode electrically coupled to the power voltage.

13. The driving circuit of claim 8, wherein the input unit further comprises:
a seventeenth transistor, a gate and a first source/drain electrode of the seventeenth transistor receiving the carry signal of a previous driving circuit unit, a second source/drain electrode of the seventeenth transistor coupling to the gate electrode of the tenth transistor.

14. The driving circuit of claim 1, wherein the clock signal further comprises a positive phase clock signal and an opposite phase clock signal.

15. The driving circuit of claim 14, wherein the positive phase clock signal and the opposite phase clock signal are the same clock signal and phases of the two clock signals are opposite.

16. The driving circuit of claim 14, wherein one of every two adjacent driving circuit units receives the positive phase clock signal and the other one receives the opposite phase clock signal.

17. The driving circuit of claim 14, wherein the pull-down circuit further comprises a positive phase pull-down circuit and an opposite phase pull-down circuit, and the positive phase pull-down circuit receives the positive phase clock signal and the opposite phase pull-down circuit receives the opposite phase clock signal.

18. The driving circuit of claim 1, further comprising:
a plurality of third control units electrically coupled to the driving circuit units respectively, wherein one of the third control units receives the output signal of the driving circuit unit two driving circuit units after.

19. The driving circuit of claim 18, wherein each of the third control units comprises a transistor having a gate electrode for receiving the output signal of the driving circuit unit two driving circuit units after, a first source/drain electrode electrically coupled to the driving circuit unit, and a second source/drain electrode electrically coupled to the power voltage.
